(19) United States
(12) Patent Application Publication
(10) Pub. No.: US 2005/0029862 A1
(43) Pub. Date: Feb. 10, 2005

(54) Vehicle motion control apparatus

(76) Inventors: Toshihisa Kato, Handa city (JP); Junya Nagaya, Kariya city (JP)

Correspondence Address: BURNS DOANE SWECKER & MATHIS L L P, POST OFFICE BOX 1404, ALEXANDRIA, VA, 22313-1404, US

(21) Appl. No.: 10/910,343

(22) Filed: Aug. 4, 2004

(30) Foreign Application Priority Data
Aug. 8, 2003 (JP) 2003-289837

(51) Int. Cl. B60T 8/56

(52) U.S. Cl. 303/146; 303/142

(57) ABSTRACT

A vehicle motion control apparatus is provided for controlling a braking force applied to each wheel in response to a vehicle state, and controlling a driving force transmitted from an internal combustion engine to driven wheels, to perform a vehicle stability control. The apparatus includes a vehicle state monitor for monitoring state variable of the vehicle, a braking force control device for controlling the braking force applied to each wheel on the basis of the state variable monitored by the vehicle state monitor, an engine output control device for controlling the driving force transmitted to the driven wheels on the basis of the state variable monitored by the vehicle state monitor, and a braking operation detection device for detecting a braking operation by a driver of the vehicle. A control distribution modifying device is provided for modifying a control distribution between the vehicle stability control performed by the braking force control device and the vehicle stability control performed by the engine output control device, when the braking operation detection device detects the braking operation during the vehicle stability control.

This application claims priority under 35 U.S.C. Sec.119 to No. 2003-289837 filed in Japan on Aug. 8, 2003, the entire content of which is herein incorporated by reference.

### BACKGROUND OF THE INVENTION

1. Field of the Invention

The present invention relates to a vehicle motion control apparatus, particularly relates to the vehicle motion control apparatus for controlling a braking force applied to each wheel in response to a vehicle state, and controlling a driving force transmitted from an internal combustion engine to driven wheels, to restrain an excessive oversteer and/or an excessive understeer, thereby to maintain stability of a vehicle in motion.

2. Description of the Related Arts

As for a vehicle motion control apparatus, there is disclosed in Japanese Patent No. 3058172, which corresponds to the U.S. Pat. No. 4,898,431, for example, an apparatus for controlling vehicle motion, by determining a desired yaw rate of a vehicle, and controlling braking force in response to a comparison of the desired yaw rate with a sensed actual yaw rate of the vehicle to maintain a vehicle stability during the vehicle motion. In Japanese Patent Laid-open publication No. 2002-356120, a vehicle motion control apparatus has been proposed, so as to maintain stability of a vehicle in motion, by decreasing the output of an engine or shift down a gear ratio of the vehicle.

And, in Japanese Patent No. 3045057, which corresponds to the U.S. Pat. No. 5,727,853, disclosed is a vehicle behavior control apparatus for terminating a behavior control when hunting might be caused in the behavior control. In practice, when the braking force is applied to a wheel and released from the same, repeatedly and continuously, it is determined that the hunting might be caused in the behavior control. In order to stable the behavior, therefore, it is proposed to prohibit the braking force from being applied to each wheel.

According to the apparatuses as disclosed in the above Patent No. 3045057 and publication No. 2002-356120, the control for maintaining the stability of the vehicle in motion (i.e., vehicle stability control) is performed. However, it is not characterized by a specific relationship with a braking operation. Therefore, the vehicle stability control will be terminated as usual, if the braking operation is made during the vehicle stability control.

Although it is proposed in the Japanese Patent No. 3045057 that when the hunting might be caused in the behavior control, the behavior control shall be terminated. As a result, the hunting will be prevented, while a tracing property will be deteriorated. Therefore, it is desired that the hunting can be prevented by decelerating the vehicle speed, with the tracing property being maintained as the effect of the stability control. Particularly, in the case where the vehicle stability control is terminated to cause the hunting when the brake pedal is depressed during the stability control, not only the apparatuses as disclosed in the above Patent No. 3058172 and publication No. 2002-356120 but also the apparatus as disclosed in the Japanese Patent No. 3045057 will not act as appropriate countermeasures against the hunting.

### SUMMARY OF THE INVENTION

Accordingly, it is an object of the present invention to provide a vehicle motion control apparatus capable of maintaining a vehicle stability control appropriately and smoothly, by controlling a braking force to each wheel in response to a vehicle state, and controlling a driving force transmitted from an internal combustion engine to driven wheels, even if a brake pedal is depressed during the vehicle stability control.

In accomplishing the above and other objects, the vehicle motion control apparatus includes a vehicle state monitor for monitoring a state variable of the vehicle, a braking force control device for controlling the braking force applied to each wheel on the basis of the state variable monitored by the vehicle state monitor to perform the vehicle stability control, an engine output control device for controlling the driving force transmitted to the driven wheels on the basis of the state variable monitored by the vehicle state monitor to perform the vehicle stability control, a braking operation detection device for detecting a braking operation by a driver of the vehicle, and a control distribution modifying device, which modifies a control distribution between the vehicle stability control performed by the braking force control device and the vehicle stability control performed by the engine output control device, when the braking operation detection device detects the braking operation during the vehicle stability control.

Preferably, the apparatus may further include a turning condition determination device for determining a turning condition of the vehicle, so that the control distribution modifying device may modify the control distribution between the vehicle stability control performed by the braking force control device and the vehicle stability control performed by the engine output control device, on the basis of a result determined by the turning condition determination device.

For instance, the control distribution modifying device is adapted to modify the control distribution so that the amount of vehicle stability control performed by the engine output control device is greater than the amount of vehicle stability control performed by the braking force control device, when the turning condition determination device determines that the vehicle is turning in one direction continuously every predetermined operation cycle.

Furthermore, the control distribution modifying device may be adapted to modify the control distribution so that the amount of vehicle stability control performed by the engine output control device is increased, comparing with the amount of vehicle stability control performed by the braking force control device, in response to the number of operation cycles with the turning operation of the vehicle held in one direction continuously every predetermined operation cycle.

The control distribution modifying device may be adapted to modify the control distribution so that the amount of vehicle stability control performed by the engine output control device is substantially equal to the amount of vehicle stability control performed by the braking force control device, when the turning condition determination device determines that the vehicle is turning in one direction in one operation cycle, and determines that the vehicle is turning in the other one direction in the next operation cycle.

And, the vehicle motion control apparatus may further include a shift control device for controlling the output of the internal combustion engine to provide a predetermined output torque transmitted to the driven wheels as the driving force, so that the control distribution modifying device may control the engine output control device and/or the shift control device on the basis of the state variable monitored by the vehicle state monitor.

In the vehicle motion control apparatus as described above, the vehicle state monitor may include a yaw rate detection device for detecting an actual yaw rate of the vehicle, and the apparatus may further include a desired yaw rate setting unit for setting a desired yaw rate on the basis of the state variable monitored by the vehicle state monitor, and a yaw rate deviation calculation unit for calculating a yaw rate deviation between the desired yaw rate set by the desired yaw rate setting unit and the actual yaw rate detected by the yaw rate detection device, so that the braking force control device and the engine output control device may perform the vehicle stability control, respectively, on the basis of the yaw rate deviation calculated by the yaw rate deviation calculation unit.

In the vehicle motion control apparatus as described above, the braking force control device may increase the braking force applied to the each wheel in response to increase of the yaw rate deviation calculated by the yaw rate deviation calculation unit, whereas the engine output control device may decrease the driving force transmitted to the driven wheels in response to increase of the yaw rate deviation calculated by the yaw rate deviation calculation unit.

### BRIEF DESCRIPTION OF THE DRAWINGS

The above stated object and following description will become readily apparent with reference to the accompanying drawings, wherein like referenced numerals denote like elements, and in which:

FIG. 1 is a schematic block diagram of a vehicle motion control apparatus according to an embodiment of the present invention;

FIG. 2 is a schematic diagram of a vehicle including a vehicle motion control apparatus according to an embodiment of the present invention;

FIG. 3 is a flowchart showing a main routine of a vehicle motion control according to an embodiment of the present invention;

FIG. 4 is a flowchart showing a subroutine for setting a control distribution according to an embodiment of the present invention;

FIG. 5A is a diagram showing an example of a map for setting a torque decreasing ratio in response to a yaw rate deviation, according to an embodiment of the present invention;

FIG. 5B is a diagram showing an example of a map for setting a braking control value in response to the yaw rate deviation, according to an embodiment of the present invention;

FIG. 6A is a diagram showing an another example of the map for setting the torque decreasing ratio in response to the yaw rate deviation, according to an embodiment of the present invention;

FIG. 6B is a diagram showing an another example of the map for setting the braking control value in response to the yaw rate deviation, according to an embodiment of the present invention;

FIG. 7A is a diagram showing a further example of the map for setting the torque decreasing ratio in response to the yaw rate deviation, according to an embodiment of the present invention;

FIG. 7B is a diagram showing a further example of the map for setting the braking control value in response to the yaw rate deviation, according to an embodiment of the present invention; and

FIG. 8 is a flowchart showing a subroutine for performing a vehicle stability control according to an embodiment of the present invention.

### DESCRIPTION OF THE PREFERRED EMBODIMENT

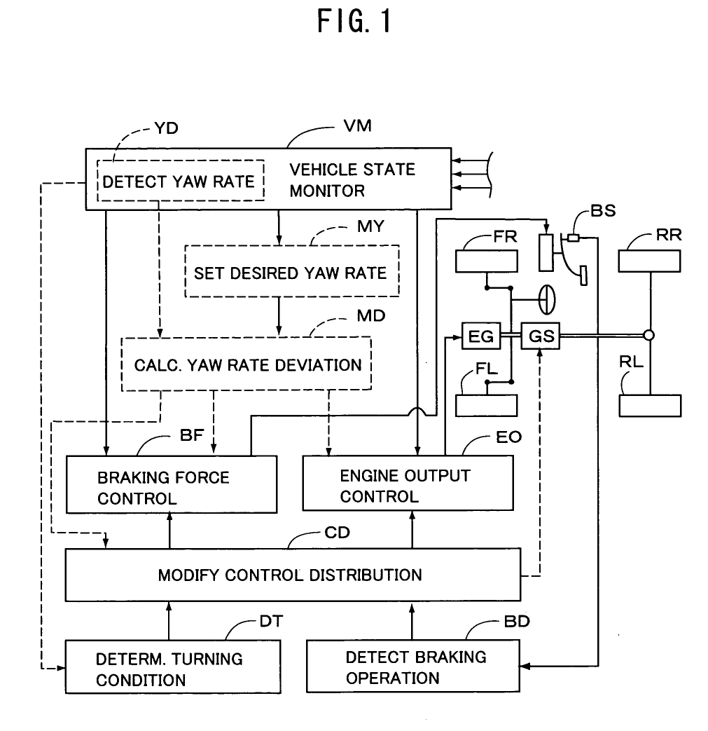

Referring to FIG. 1, there is schematically illustrated a vehicle motion control apparatus according to an embodiment of the present invention, which is provided with a vehicle state monitor VM for monitoring a state variable of a vehicle, such as wheel speeds, yaw rate, steering angle, or the like. A braking force control device BF is provided for controlling the braking force applied to each wheel FR or the like on the basis of the state variable monitored by the vehicle state monitor VM to perform the vehicle stability control. An engine output control device EO is provided for controlling the driving force transmitted from an internal combustion engine EG to driven wheels RR and RL on the basis of the state variable monitored by the vehicle state monitor VM to perform the vehicle stability control. A braking operation detection device BD is provided for detecting a braking operation by a driver of the vehicle. And, there is provided a control distribution modifying device CD for modifying a control distribution between the vehicle stability control performed by the braking force control device BF and the vehicle stability control performed by the engine output control device EO, when the braking operation detection device BD detects the braking operation during the vehicle stability control.

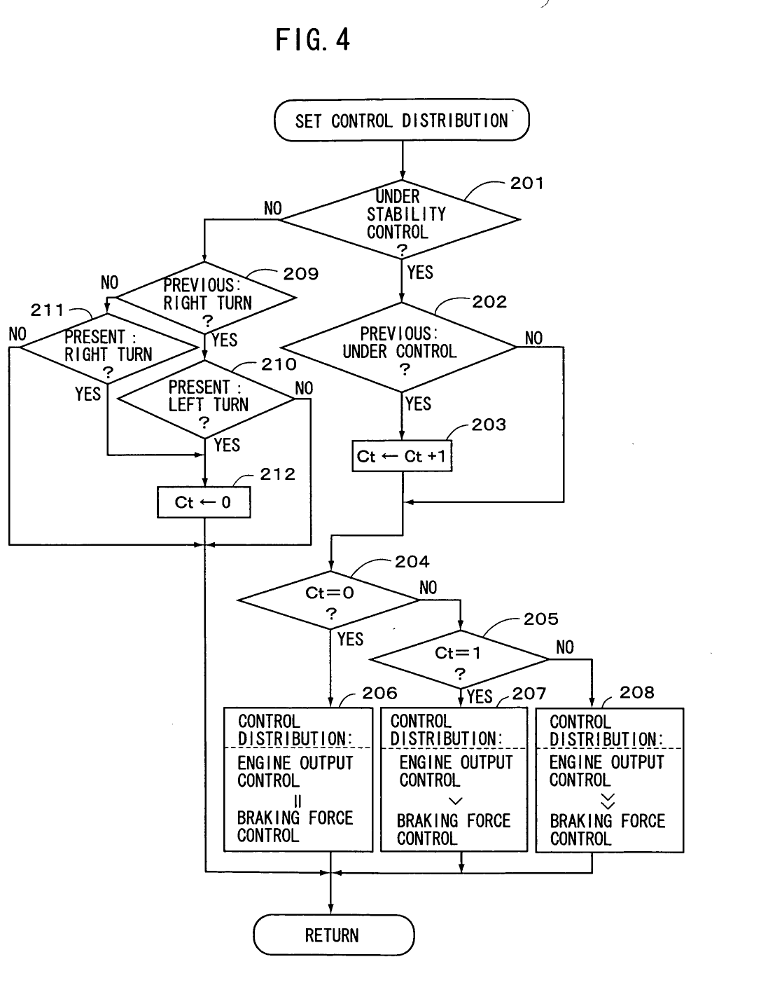

According to the present embodiment, a turning condition determination device DT is provided for determining a turning condition of the vehicle, whereby the control distribution modifying device CD is adapted to modify the control distribution between the vehicle stability control performed by the braking force control device BF and the vehicle stability control performed by the engine output control device EO, on the basis of a result determined by the turning condition determination device DT. That is, the amount of vehicle stability control performed by the engine output control device EO is modified to be greater than the amount of vehicle stability control performed by the braking force control device BF, when the turning condition determination device DT determines that the vehicle is turning in one direction continuously every predetermined operation cycle. In addition, the control distribution modifying device CD may be adapted to modify the control distribution so that the amount of vehicle stability control performed by the engine output control device EO is increased, comparing with the amount of vehicle stability control performed by the braking force control device BF, in response to the number of operation cycles with the turning operation of the vehicle held in one direction continuously every predetermined operation cycle. On the contrary, when the turning condition determination device DT determines that the vehicle is turning in one direction (e.g., left turn) in one operation cycle, and determines that the vehicle is turning in the other one direction (e.g., right turn) in the next operation cycle, the amount of vehicle stability control performed by the engine output control device EO is modified to be substantially equal to the amount of vehicle stability control performed by the braking force control device BF, as will be described later in detail with reference to FIG. 4.

As indicated by broken lines in FIG. 1, the vehicle state monitor VM may include a yaw rate detection device YD for detecting an actual yaw rate of the vehicle. In this case, therefore, there are provided a desired yaw rate setting unit MY for setting a desired yaw rate on the basis of the state variable monitored by the vehicle state monitor VM, and a yaw rate deviation calculation unit MD for calculating a yaw rate deviation between the desired yaw rate set by the desired yaw rate setting unit MY and the actual yaw rate detected by the yaw rate detection device YD. Then, the braking force control device BF is adapted to increase the braking force applied to the each wheel FR or the like in response to increase of the yaw rate deviation calculated by the yaw rate deviation calculation unit MD, whereas the engine output control device EO is adapted to decrease the driving force transmitted to the driven wheels RR and RL in response to increase of the yaw rate deviation calculated by the yaw rate deviation calculation unit MD.

Furthermore, as indicated by broken lines in FIG. 1, a shift control device GS may be provided for controlling the output of the internal combustion engine EG to provide a predetermined output torque transmitted to the driven wheels RR and RL as the driving force, so that the control distribution modifying device CD may control the engine output control device EO and/or the shift control device GS on the basis of the state variable monitored by the vehicle state monitor VM.

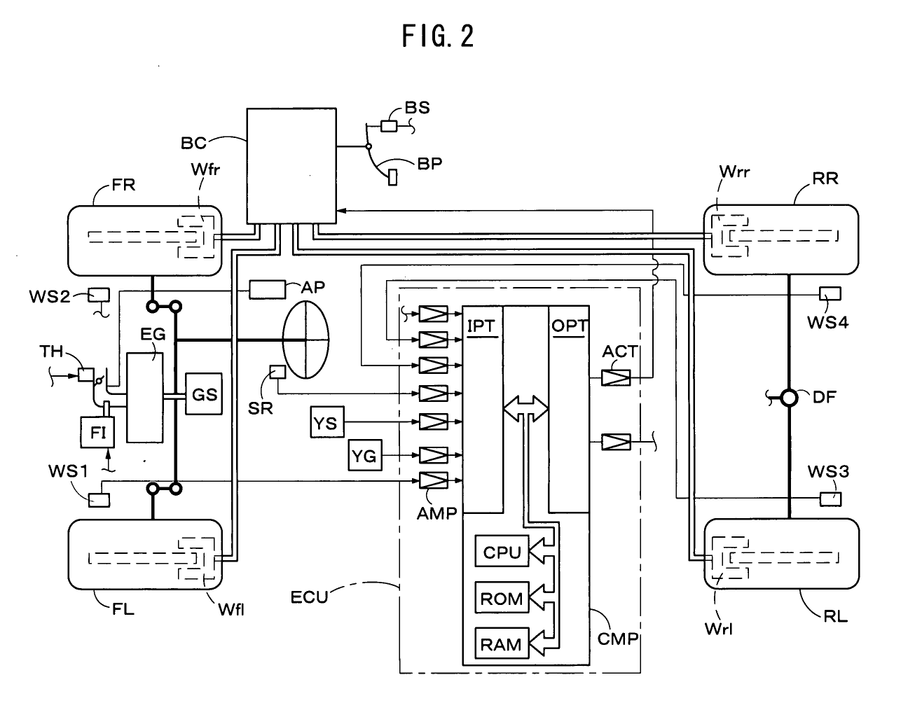

FIG. 2 shows a vehicle including the embodiment as shown in FIG. 1, and having the engine EG provided with a fuel injection apparatus FI and a throttle control apparatus TH which is adapted to control a throttle opening in response to operation of an accelerator pedal AP. Also, the throttle opening of the throttle control apparatus TH is controlled and the fuel injection apparatus FI is actuated to control the fuel injected into the engine EG, in response to output of an electronic control unit ECU. In FIG. 2, a wheel FL designates the wheel at the front left side as viewed from the position of a driver's seat, a wheel FR designates the wheel at the front right side, a wheel RL designates the wheel at the rear left side, and a wheel RR designates the wheel at the rear right side. These wheels are operatively associated with wheel brake cylinders Wfl, Wfr, Wrl and Wrr, respectively. According to the present embodiment, the engine EG is operatively connected with the rear wheels RL and RR through a differential gear apparatus DF and the shift control device GS, which is controlled in response to output of the electronic control unit ECU, so that a shift-down can be made automatically to provide a so-called engine-brake for reducing a vehicle speed. Thus, a so-called rear drive system is constituted in FIGS. 1 and 2, while the drive system is not limited to the rear drive system, but the present invention is applicable to a front drive system or a four-wheel drive system.

In the vicinity of the wheels FL, FR, RL and RR, there are provided wheel speed sensors WS1-WS4, respectively, which are connected to the electronic control unit ECU, and by which a signal having pulses proportional to a rotational speed of each wheel, i.e., a wheel speed signal is fed to the electronic control unit ECU. There are also provided a brake switch BS which turns on when the brake pedal BP is depressed, and turns off when the brake pedal BP is released, to serve as the braking operation detection device BD, a steering angle sensor SR for detecting a steering angle of the vehicle, a yaw rate sensor YS for detecting a yaw rate of the vehicle, which serves as the yaw rate detection device YD, a lateral acceleration sensor YG for detecting a vehicle lateral acceleration, a throttle sensor (not shown) and the like. These are electrically connected to the electronic control unit ECU to control the engine EG and/or a hydraulic brake control device BC, which may be the same as the one shown in the Japanese Patent No. 3045057, for example.

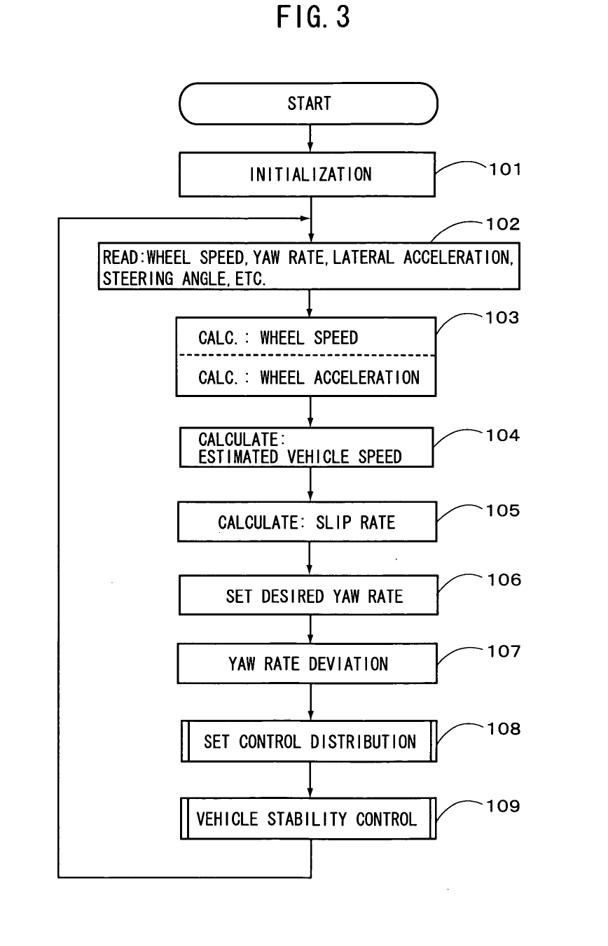

As shown in FIG. 2, the electronic control unit ECU is provided with a microcomputer CMP which includes a central processing unit or CPU, a read-only memory or ROM, a random access memory or RAM, an input port IPT, an output port OPT and the like. The signals detected by the wheel speed sensors WS1-WS4, yaw rate sensor YS, lateral acceleration sensor YG, steering angle sensor SR, brake switch BS and the like are fed to the input port IPT via respective amplification circuits AMP and then to the central processing unit CPU. Then, control signals are fed from the output port OPT to the throttle control apparatus TH and hydraulic brake control device BC via the respective driving circuits ACT. In the microcomputer CMP, the memory ROM memorizes a program corresponding to flowcharts as shown in FIGS. 3, 4 and 8, the central processing unit CPU executes the program while the ignition switch (not shown) is closed, and the memory RAM temporarily memorizes variable data required to execute the program. In the electronic control unit ECU, therefore, there are constituted the vehicle state monitor VM, braking force control device BF, engine output control device EO, control distribution modifying device CD, turning condition determination device DT, desired yaw rate setting unit MY, yaw rate deviation calculation unit MD and the like, as shown in FIG. 1.

According to the present embodiment as constituted above, a program routine for the vehicle stability control is executed by the electronic control unit ECU, as will be described hereinafter with reference to FIG. 3. The program routine begins when an ignition switch (not shown) is turned on. At the outset, the program provides for initialization of the system at Step 101 to clear various data, and proceeds to Steps 102-109, which are repeated at a predetermined time period. At Step 102, read by the electronic control unit ECU are the signals indicative of vehicle state variable such as wheel speed Vw, yaw rate Ya, lateral acceleration Gy, steering angle As and the like, which are detected by the wheel speed sensors WS1-WS4, yaw rate sensor YS, lateral acceleration sensor YG, steering angle sensor SR, brake switch BS and the like. Those signals are filtered, and stored in the memory. Then, the program proceeds to Step 103 where a reference wheel speed (Vr) of each wheel is calculated on the basis of the wheel speeds (Vw) output from the wheel speed sensors WS1-WS4, and it is differentiated to provide a wheel acceleration of each wheel. According to the present embodiment, the detected wheel speeds are converted into a speed on the gravity center of the vehicle, on the basis of which the reference wheel speed Vr is calculated for each wheel. Then, an estimated vehicle speed V is calculated at Step 104, and an actual slip rate Sa (=(Vs−V)/V), or wheel slip, is calculated at Step 105.

Next, at Step 106, on the basis of the vehicle state variable as described above, a desired yaw rate is calculated. In this embodiment, a desired yaw rate Yto for the oversteer restraining control and a desired yaw rate Ytu for the understeer restraining control are provided as follows:
At the outset, the desired yaw rate Yto is calculated on the basis of the lateral acceleration Gy and estimated vehicle speed V as described above, as [Yto=Gy/V]. Then, the desired yaw rate Ytu is calculated on the basis of the lateral acceleration Gy, steering angle As, estimated vehicle speed V and etc, as follows;
   Ytu=Gy/V+C[(V·As)/{N·L·(1+K·V²)}−Gy/V],
where “N” indicates a steering gear ratio, “L” indicates a wheelbase, “K” indicates a stability factor, and “C” indicates a weighted factor.

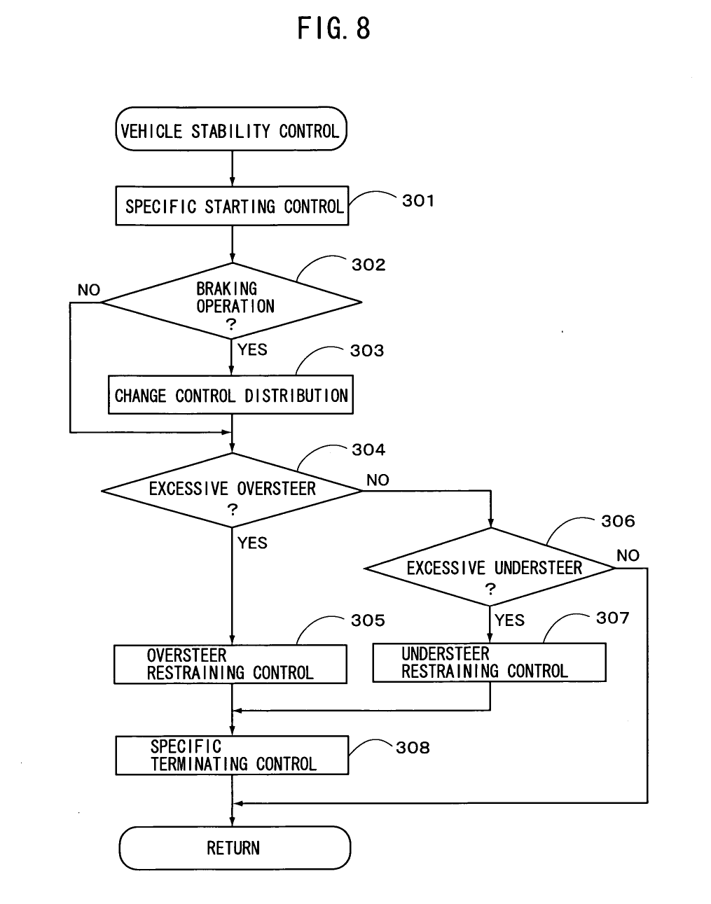

Then, calculated at Step 107 are a yaw rate deviation ΔYto (=Yto−Ya) between the actual yaw rate Ya detected by the yaw rate sensor YS and the desired yaw rate Yto, or a yaw rate deviation ΔYtu (=Ytu−Ya) between the actual yaw rate Ya and the desired yaw rate Ytu, and set at Step 108 is a control distribution between the vehicle stability control performed by the braking force control device BF and the vehicle stability control performed by the engine output control device EO. Thereafter, the vehicle stability control is performed at Step 109. That is, after the control distribution was set as shown in FIG. 4, the control for restraining the excessive oversteer and/or the excessive understeer are performed, as will be described later in detail with reference to FIG. 8. When the yaw rate deviation ΔYto is of negative value, it is determined that the vehicle is under the oversteer state, and otherwise it is under the understeer state.

Next, referring to FIG. 4, will be explained operation of setting the control distribution to be performed at Step 108 as described above. In the case where the vehicle stability control is performed repeatedly when the vehicle is turning in a certain direction (the same direction), it is determined that the hunting might be caused, so that the control distribution will be changed. At Step 201, it is determined whether the vehicle stability control is being performed at present, i.e., the present operation cycle, or not. If it is determined that the vehicle stability control is being performed, the program proceeds to Step 202 where it is determined that the vehicle stability control was being performed at the previous operation cycle (herein after, simply referred to as cycle). If it is determined at Step 202 that the vehicle stability control was not being performed, the program proceeds to Step 204, whereas if it is determined that the vehicle stability control was being performed at the previous cycle, the program proceeds to Step 203 where a counter (Ct) for determining the hunting is incremented to provide (Ct+1), then proceeds to Step 204.

At Step 204, it is determined whether the counter (Ct) is zero or not, i.e., it is determined whether the vehicle stability control has begun at the present cycle, or not. If it is determined that the vehicle stability control performed at the present cycle is the one performed for the first time, the program proceeds to Step 206, whereas if it is determined at Step 204 that the counter (Ct) is not zero, the program further proceeds to Step 205 where the counter (Ct) is one (1) or not. In other words, it is determined whether the vehicle stability control has been performed continuously more than twice (of the present cycle and the previous cycle). If it is determined that the vehicle stability control was under control at the previous cycle, and it is under control at the present cycle, the program proceeds to Step 207. If it is determined at Step 205 that the vehicle stability control was under control for the number of cycles equal to or more than three cycles (i.e., Ct≧2) continuously, then the program proceeds to Step 208, where the control distribution between the vehicle stability control performed by the braking force control device BF and the vehicle stability control performed by the engine output control device EO is modified relatively in accordance with the individual case, at Steps 206 and 207, as well. That is, at Step 206, the vehicle stability control performed by the braking force control device BF and the vehicle stability control performed by the engine output control device EO are set to be equal to each other. Whereas, at Step 207, the vehicle stability control performed by the engine output control device EO is set to be greater in ratio, comparing with the vehicle stability control performed by the braking force control device BF, as shown in FIGS. 6A and 6B. Furthermore, at Step 208, the vehicle stability control performed by the engine output control device EO is set to be much greater in ratio, comparing with the vehicle stability control performed by the braking force control device BF, as shown in FIGS. 7A and 7B.

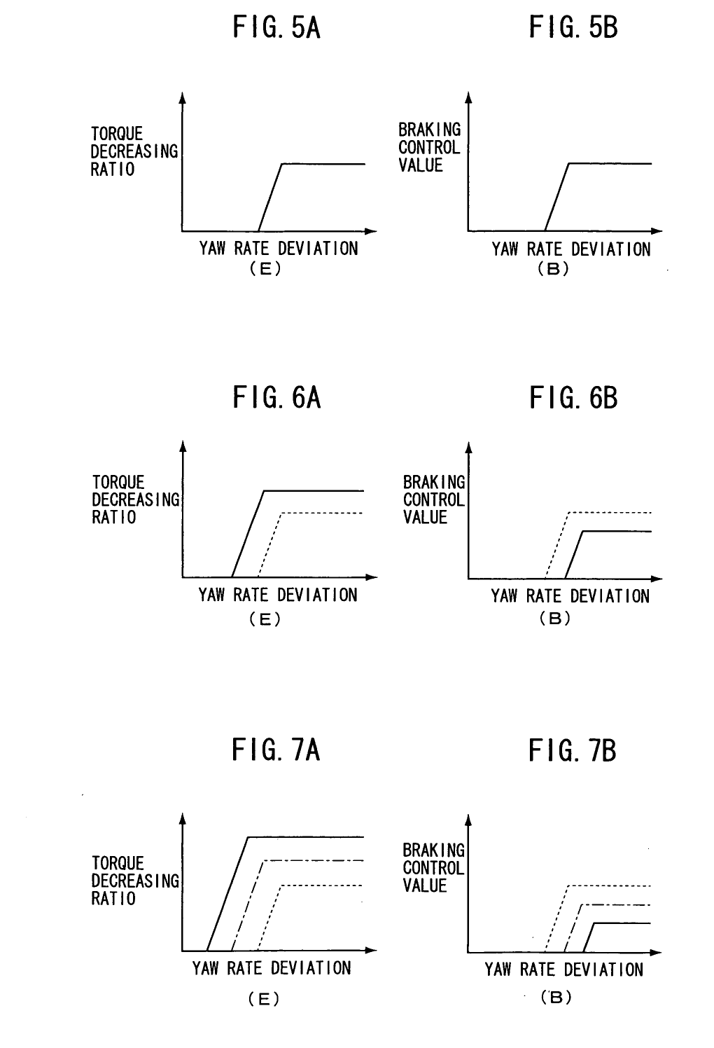

With respect to the ratio provided in FIGS. 5A-7B for the vehicle stability control, the vehicle stability control performed by the engine output control device EO is so provided as to increase the torque decreasing ratio (or, torque down rate) of the threshold value for initiating the stability control performed by the engine EG and/or gear shift control device GS against the yaw rate deviation (e.g., ΔYtu) as indicated by (E) in each Figure, whereas the vehicle stability control performed by the braking force control device BF is so provided as to increase the braking control value (e.g., regulated amount for each wheel cylinder pressure) of the threshold value for initiating the control against the yaw rate deviation as indicated by (B) in each Figure. And, the ratio as shown in (E) and the value as shown in (B) in each Figure are increased or decreased relatively with each other. For example, it is so provided that broken lines in (E) and (B) of FIGS. 6A and 6B indicate the threshold values in (E) and (B) of FIGS. 5A and 5B, and that the one-dot chain line in (E) and (B) of FIGS. 7A and 7B indicates the threshold values in (E) and (B) of FIGS. 6A and 6B. In other words, it is so provided that the torque decreasing ratio is larger and the stability control begins earlier in (E) of FIG. 6A than in (E) of FIG. 5A. Also, it is so provided that the torque decreasing ratio is much larger and the stability control begins much earlier in (E) of FIG. 7A than in (E) of FIGS. 5A and 6A. And, it is so provided that the braking control value is smaller and the control begins later in (B) of FIG. 6B, than in (B) of FIG. 5B. Also, it is so provided that the braking control value is much smaller and the stability control begins much later in (B) of FIG. 7B than in (B) of FIGS. 5B and 6B.

Referring back to FIG. 4, if it is determined at Step 201 that the vehicle stability control is not being performed at the present cycle, the program proceeds to Step 209 and following Steps, where it is determined whether the turning direction of the vehicle has been changed or not. At Step 209, it is determined whether the vehicle was turning to the right at the previous cycle, and if the result is affirmative, the program proceeds to Step 210, where it is determined whether the vehicle is turning to the left at the present cycle. If the result is affirmative at Step 210, it means that the turning direction of the vehicle has been changed. In this case, therefore, it is estimated that the vehicle stability control has been performed without causing the hunting, so that the program proceeds to Step 212, the counter (Ct) is cleared to be zero. In the case where it was determined at Step 209 that the vehicle was turning to the right at the previous cycle, and it is determined at Step 210 that the vehicle is not turning to the left at the present cycle, and in the case where it was determined at Step 209 that the vehicle was not turning to the right at the previous cycle, and it is determined at Step 211 that the vehicle is not turning to the right at the present cycle, it means that the vehicle is turning in the same direction, the counter (Ct) is set to be held in the same value, then the program returns to the main routine. At the next cycle, therefore, with the counter (Ct) set in the previous cycle, the routine starting from Step 201 will be repeated, in the same manner as described above.

With respect to determination of the turning direction as executed in the above Steps, it may be determined on the basis of a direction to which a steering wheel is turned from a neutral position (zero point) of steering angle detected by the steering angle sensor SR for example, either to the side of positive value or to the side of negative value. Or, it may be determined by comparing the wheel speeds of right and left wheels, so that if a difference between those wheel speeds exceeds a predetermined value, it can be determined that the vehicle is turning, with the wheel having the wheel speed thereof greater than that of the other wheel being located on the outside of the curve, and with the wheel having the wheel speed thereof smaller than that of the other wheel being located on the inside of the curve. Any other known methods for determining it may be employed.

Next, referring to FIG. 8, will be explained operation of the vehicle stability control. After a specific starting control is performed at Step 301 if necessary, the program proceeds to Step 302 where the state of brake switch BS is determined. If the brake pedal BP has not been depressed so that the brake switch BS is in its off state, the program proceeds to Step 304, whereas if the brake pedal BP has been depressed so that the brake switch BS is in its on state, the program proceeds to Step 303 where the control distribution will be changed, and then to Step 304. At Step 303, the control distribution between the vehicle stability control performed by the braking force control device BF and the vehicle stability control performed by the engine output control device EO is changed into the control distribution set at Step 108 in FIG. 3. For example, the control distribution as shown in FIGS. 5A and 5B is changed into the control distribution as shown in FIGS. 6A and 6B, or FIGS. 7A and 7B. Consequently, the control distribution performed by the engine output control device EO is modified to share the greater part of the control distribution, in case of the braking operation which is likely to cause the hunting. As to which of the control distribution as shown in FIGS. 6A and 6B or FIGS. 7A and 7B changed from the control distribution as shown in FIGS. 5A and 5B, it may be determined on the basis of the braking condition. For example, it may be set on the basis of the number of wheels under the anti-skid operation. If the number of wheels under the anti-skid operation is relatively large, the control distribution as shown in FIGS. 7A and 7B may be selected.

Then, at Step 304, an absolute value of the deviation ΔYto is compared with a reference value K0. If it is determined that the absolute value of the yaw rate deviation (hereinafter, referred to as deviation) ΔYto is equal to or greater than the reference value Ko, it is determined that the vehicle is under the excessive oversteer state, the program proceeds to Step 305 where the oversteer restraining control is performed. On the contrary, if it is determined that the absolute value of the deviation ΔYto is smaller than the reference value Ko, the program proceeds to Step 306 where the deviation ΔYtu is compared with a reference value Ku. If it is determined that the deviation ΔYtu is equal to or greater than the reference value Ku, it is determined that the vehicle is under the excessive understeer state, the program proceeds to Step 307 where the understeer restraining control is performed. According to the present embodiment, in case of the understeer restraining control, with respect to the wheels operatively associated with the wheel brake cylinders included in a single hydraulic circuit, the wheel FR (or FL) positioned at the front outside of the vehicle is determined to be a wheel not to be controlled (abbreviated to uncontrolled wheel), and the braking force is applied to the wheel RL (or RR) positioned at the rear inside of the vehicle on the diagonal line to the wheel FR (or FL), thereby to perform a so-called diagonal control system. In practice, the wheel cylinder pressure is held with respect to the wheel FR (or FL) positioned at the front outside of the vehicle, whereas the wheel cylinder pressure is regulated for the wheel brake cylinder Wrl (or Wrr) operatively associated with the wheel RL (or RR) positioned at the rear inside of the vehicle. After the control as described above is finished, a specific terminating control is performed at Step 308, and the program returns to the main routine as shown in FIG. 3. Although the hydraulic braking pressure in the wheel brake cylinder operatively associated with the uncontrolled wheel has been held during the understeer restraining control performed at Step 307 for the controlled wheel, the hydraulic braking pressure (wheel cylinder pressure) may be regulated with respect to the uncontrolled wheel, in accordance with the relationship with the hydraulic braking pressure in the wheel brake cylinder operatively associated with the controlled wheel.

It should be apparent to one skilled in the art that the above-described embodiment is merely illustrative of but one of the many possible specific embodiments of the present invention. Numerous and various other arrangements can be readily devised by those skilled in the art without departing from the spirit and scope of the invention as defined in the following claims.

1. A vehicle motion control apparatus for controlling a braking force applied to each wheel in response to a vehicle state, and controlling a driving force transmitted from an internal combustion engine to driven wheels, to perform a vehicle stability control, comprising:
vehicle state monitor means for monitoring a state variable of said vehicle;
braking force control means for controlling the braking force applied to said each wheel on the basis of the state variable monitored by said vehicle state monitor means to perform the vehicle stability control;
engine output control means for controlling the driving force transmitted to said driven wheels on the basis of the state variable monitored by said vehicle state monitor means to perform the vehicle stability control;
braking operation detection means for detecting a braking operation by a driver of said vehicle; and
control distribution modifying means for modifying a control distribution between the vehicle stability control performed by said braking force control means and the vehicle stability control performed by said engine output control means, when said braking operation detection means detects the braking operation during the vehicle stability control.

2. A vehicle motion control apparatus as set forth in claim 1, further comprising turning condition determination means for determining a turning condition of said vehicle, wherein said control distribution modifying means modifies the control distribution between the vehicle stability control performed by said braking force control means and the vehicle stability control performed by said engine output control means, on the basis of a result determined by said turning condition determination means.

3. A vehicle motion control apparatus as set forth in claim 2, wherein said control distribution modifying means modifies the control distribution so that the amount of vehicle stability control performed by said engine output control means is greater than the amount of vehicle stability control performed by said braking force control means, when said turning condition determination means determines that said vehicle is turning in one direction continuously every predetermined operation cycle.

4. A vehicle motion control apparatus as set forth in claim 3, wherein said vehicle state monitor means includes yaw rate detection means for detecting an actual yaw rate of said vehicle, said apparatus further comprising;
desired yaw rate setting means for setting a desired yaw rate on the basis of the state variable monitored by said vehicle state monitor means, and
yaw rate deviation calculation means for calculating a yaw rate deviation between the desired yaw rate set by said desired yaw rate setting means and the actual yaw rate detected by said yaw rate detection means,
and wherein said braking force control means increases the braking force applied to said each wheel in response to increase of the yaw rate deviation calculated by said yaw rate deviation calculation means, and said engine output control means decreases the driving force transmitted to said driven wheels in response to increase of the yaw rate deviation calculated by said yaw rate deviation calculation means.

5. A vehicle motion control apparatus as set forth in claim 3, wherein said control distribution modifying means modifies the control distribution so that the amount of vehicle stability control performed by said engine output control means is increased, comparing with the amount of vehicle stability control performed by said-braking force control means, in response to the number of operation cycles with the turning operation of said vehicle held in one direction continuously every predetermined operation cycle.

6. A vehicle motion control apparatus as set forth in claim 5, wherein said vehicle state monitor means includes yaw rate detection means for detecting an actual yaw rate of said vehicle, said apparatus further comprising;
desired yaw rate setting means for setting a desired yaw rate on the basis of the state variable monitored by said vehicle state monitor means, and
yaw rate deviation calculation means for calculating a yaw rate deviation between the desired yaw rate set by said desired yaw rate setting means and the actual yaw rate detected by said yaw rate detection means,
and wherein said braking force control means increases the braking force applied to said each wheel in response to increase of the yaw rate deviation calculated by said yaw rate deviation calculation means, and said engine output control means decreases the driving force transmitted to said driven wheels in response to increase of the yaw rate deviation calculated by said yaw rate deviation calculation means.

7. A vehicle motion control apparatus as set forth in claim 3, wherein said control distribution modifying means the control distribution so that the amount of vehicle stability control performed by said engine output control means is substantially equal to the amount of vehicle stability control performed by said braking force control means, when said turning condition determination means determines that said vehicle is turning in one direction in one operation cycle, and determines that said vehicle is turning in the other one direction in the next operation cycle.

8. A vehicle motion control apparatus as set forth in claim 7, wherein said vehicle state monitor means includes yaw rate detection means for detecting an actual yaw rate of said vehicle, said apparatus further comprising;
desired yaw rate setting means for setting a desired yaw rate on the basis of the state variable monitored by said vehicle state monitor means, and
yaw rate deviation calculation means for calculating a yaw rate deviation between the desired yaw rate set by said desired yaw rate setting means and the actual yaw rate detected by said yaw rate detection means,
and wherein said braking force control means increases the braking force applied to said each wheel in response to increase of the yaw rate deviation calculated by said yaw rate deviation calculation means, and said engine output control means decreases the driving force transmitted to said driven wheels in response to increase of the yaw rate deviation calculated by said yaw rate deviation calculation means.

9. A vehicle motion control apparatus as set forth in claim 1, further comprising shift control means for controlling the output of said internal combustion engine to provide a predetermined output torque transmitted to said driven wheels as the driving force, wherein said control distribution modifying means controls said engine output control means and/or said shift control means on the basis of the state variable monitored by said vehicle state monitor means.

10. A vehicle motion control apparatus as set forth in claim 1, wherein said vehicle state monitor means includes yaw rate detection means for detecting an actual yaw rate of said vehicle, said apparatus further comprising;
desired yaw rate setting means for setting a desired yaw rate on the basis of the state variable monitored by said vehicle state monitor means, and
yaw rate deviation calculation means for calculating a yaw rate deviation between the desired yaw rate set by said desired yaw rate setting means and the actual yaw rate detected by said yaw rate detection means, and wherein said braking force control means and said engine output control means perform the vehicle stability control, respectively, on the basis of the yaw rate deviation calculated by said yaw rate deviation calculation means.

11. A vehicle motion control apparatus as set forth in claim 10, wherein said braking force control means increases the braking force applied to said each wheel in response to increase of the yaw rate deviation calculated by said yaw rate deviation calculation means, and said engine output control means decreases the driving force transmitted to said driven wheels in response to increase of the yaw rate deviation calculated by said yaw rate deviation calculation means.
